(19) United States
(12) Patent Application Publication
(10) Pub. No.: US 2026/0251482 A1
(43) Pub. Date: Aug. 27, 2026

(54) POSITION DETECTING SYSTEM, ACTUATOR, AND POSITION DETECTING METHOD

(71) Applicant: Fanuc Corporation, Minamitsuru-gun, Yamanashi (JP)

(72) Inventor: Taichi TAGUCHI, Minamitsuru-gun, Yamanashi (JP)

(73) Assignee: Fanuc Corporation, Minamitsuru-gun, Yamanashi (JP)

(21) Appl. No.: 18/877,371

(22) PCT Filed: Jul. 8, 2022
(86) PCT No.: PCT/JP2022/027155

§ 371 Date: Dec. 20, 2024

(51) Int. Cl. G01D 5/244

(52) U.S. Cl. CPC G01D 5/24447; G01D 5/24485; G01D 2205/26

(57) ABSTRACT

A position detecting system includes a primary encoder detecting the position of a motor shaft of a motor, and a secondary encoder detecting the position of an output shaft of a reducer. The position detecting system further includes encoder power sources energizing and operating, in a predetermined situation, at least one of the primary encoder and the secondary encoder.

### CROS REFERENCE TO RELATED APPLICATIONS

This is the U.S. National Phase application of PCT/JP 2022/027155, filed Jul. 8, 2022, the disclosure of this application being incorporated herein by reference in its entirety for all purposes.

### FIELD OF THE INVENTION

The present invention relates to a position detection system, an actuator, and a position detection method.

### BACKGROUND OF THE INVENTION

Actuators include a servo motor and a speed reducer that are connected to each other. A primary encoder is connected to a motor shaft of the servo motor for detecting an absolute position within one rotation of the motor shaft and the total number of rotations of the motor shaft. Likewise, a secondary encoder is connected to an output shaft of the speed reducer for detecting an absolute position within one rotation of the output shaft and the total number of rotations of the output shaft (refer to, for example, Japanese Unexamined Patent Publication (Kokai) No. 2007-113932). Information detected by each encoder is stored in a memory.

In specific situations, such as when the servo motor stops and the output shaft of the speed reducer rotates by inertia, as long as the output shaft of the speed reducer rotates within one rotation, the total number of rotations of the primary encoder can be obtained based on the absolute position information of the secondary encoder. In this case, each encoder can be used continuously without the use of an additional battery.

### Patent Literature

PTL 1: Japanese Unexamined Patent Publication (Kokai) No. 2007-113932

### SUMMARY OF THE INVENTION

The actuator described above may be incorporated into a specific machine, such as a robot, having a shaft which can rotate between ±360° and ±720° (between one and two rotations). If the shaft rotates between one and two rotations, an additional battery must be prepared to continue using each encoder.

Thus, an encoder which can be used continuously throughout the entire range of motion of a shaft without the need for an additional battery is desired.

According to a first aspect of the present disclosure, there is provided a position detection system comprising a motor mounted in a machine, a speed reducer coupled to the motor, a primary encoder for detecting a position of a motor shaft of the motor, and a secondary encoder for detecting a position of an output shaft of the speed reducer, and further comprising an encoder power source for energizing and operating at least one of the primary encoder and the secondary encoder in a predetermined situation.

According to another aspect of the present disclosure, there is provided an actuator comprising a motor, a speed reducer coupled to the motor, a primary encoder for detecting a position of a motor shaft of the motor, and a secondary encoder for detecting a position of an output shaft of the speed reducer, and further comprising an encoder power source for energizing and operating at least one of the primary encoder and the secondary encoder in a predetermined situation.

According to yet another aspect of the present disclosure, there is provided a position detection method for a position detection system comprising a primary encoder for detecting a position of a motor shaft of a motor and a secondary encoder for detecting a position of an output shaft of a speed reducer coupled to the motor, the method comprising the steps of in response to a stop command for the machine, stopping power supply to the motor, whereby the rotor of the motor moves by inertia, by means of an encoder power source, energizing and operating at least one of the primary encoder and the secondary encoder, and storing the position of at least one of the primary encoder and the secondary encoder when the output shaft stops.

The object, features, and advantages of the present disclosure will become more apparent from the following description of the embodiments in conjunction with the accompanying drawings.

### BRIEF DESCRIPTION OF THE DRAWINGS

FIG. 1 is a schematic side view of a position detection system based on first and second embodiments of the present disclosure.

FIG. 2 is a flowchart showing the operation of the position detection system based on the first embodiment.

FIG. 3 is a flowchart showing the operation of the position detection system based on the second embodiment.

FIG. 4 is a view showing the relationship between time and the position of the output shaft of a speed reducer.

### DETAILED DESCRIPTION OF EMBODIMENTS OF THE INVENTION

The embodiments of the present disclosure will be described below with reference to the attached drawings. In the drawings, corresponding constituent elements have been assigned common reference signs.

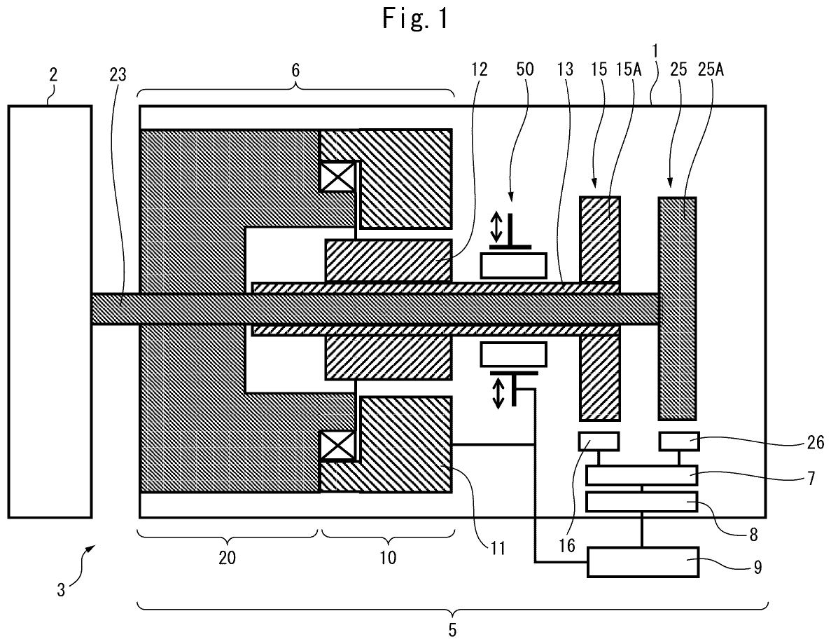

FIG. 1 is a schematic side view of a position detection system based on a first embodiment of the present disclosure. The position detection system 5 is incorporated into a machine 3 having a shaft, for example, a robot 3. Though the case in which the position detection system 5 is incorporated into the robot 3 will be described below, the same applies to the case in which the position detection system 5 is incorporated into another machine 3 having a shaft, for example, a machine tool.

In FIG. 1, an actuator 6 arranged in a link 1 comprises a motor 10, for example, a servo motor and a speed reducer 20 coupled to a motor shaft 13 of the motor 10, which are connected with each other. The motor 10 comprises a rotor 12 which rotates integrally with the motor shaft 13, and a stator 11 arranged so as to surround the rotor 12. The tip of an output shaft 23 of the speed reducer 20 is connected to a link 2. Thus, the actuator 6 composed of the motor 10 and the speed reducer 20 rotates the link 2 relative to the link 1 within a predetermined operating range to perform positioning control thereof. The reduction ratio of the speed reducer 20 is, for example, 1:50.

The motor shaft 13 is, for example, a hollow shaft, and has a primary encoder 15 attached to a rear end thereof. The primary encoder 15 is, for example, an incremental encoder, and outputs A-phase, B-phase, and Z-phase signals. The output signals are detected by a detection unit 16, which detects an absolute position PA1 within one rotation of the motor shaft 13 and a total number of rotations PB1 by a known method. The detected information is stored in a memory 7, for example, a volatile memory.

The output shaft 23 extends through the hollow motor shaft 13 toward the motor 10 side, and a secondary encoder 25 is attached to a rear end of the output shaft 23. The secondary encoder 25 is, for example, an incremental encoder, and outputs A-phase, B-phase, and Z-phase signals. The output signals are detected by a detection unit 26, which detects an absolute position PA2 within one rotation of the output shaft 23 and a total number of rotations PB2 by a known method. The detected information is stored in a memory 7, for example, a volatile memory. As is known, the primary encoder 15 and the secondary encoder 25 comprise respective rotating disks 15A, 25A.

The information stored in the memory 7 is capable of being stored for a certain period of time due to a battery 8, for example, a button battery or a capacitor. The position detection system 5 shown in FIG. 1 comprises a common memory 7 and a common battery 8 for the primary encoder 15 and the secondary encoder 25. However, the primary encoder 15 and the secondary encoder 25 may each have a separate memory and battery.

The information stored in the memory 7 is supplied to a controller 9 for controlling the machine 3. The controller 9 may be an LSI mounted on the encoders 15 and 25. Based on the supplied information, the controller 9 drives and controls the motor 10, and performs a positioning operation to position the link 2 at a target position relative to the link 1. Further, a built-in brake 50 provided on the outer surface side of the motor shaft 13 is activated in response to an instruction from the controller 9 to brake the motor shaft 13. Furthermore, the controller 9 also serves to energize the primary encoder 15 and the secondary encoder 25 during operation of the machine 3 comprising the links 1 and 2.

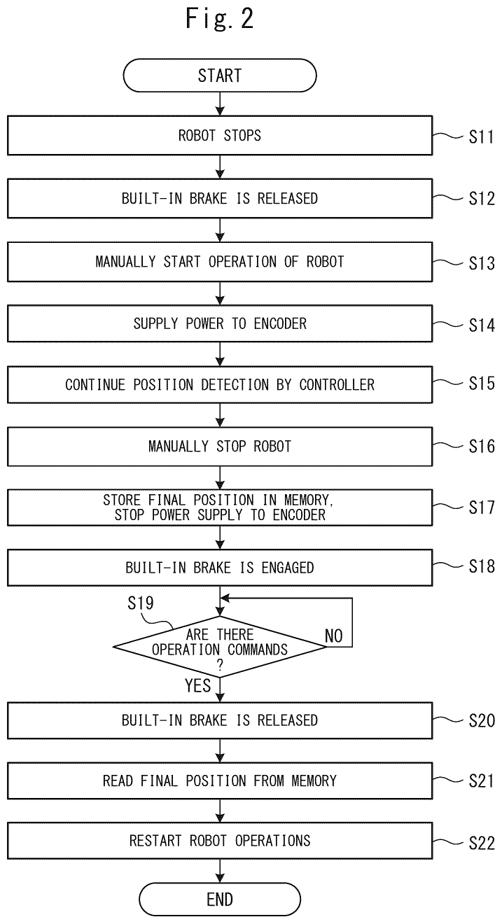

FIG. 2 is a flowchart showing the operation of the position detection system based on the first embodiment. The contents shown in FIG. 2 are implemented, for example, when the machine 3, for example, a robot 3, which is operating in accordance with operation commands, stops due to a specific cause and it is necessary to resume the operations of the machine 3. The program related to the operations shown in FIG. 2 is stored in a storage unit (not illustrated) connected to the controller 9. Below, the case in which the machine 3 is a robot 3 will be described, but the same can be applied when the machine 3 is a machine tool or the like.

First, in step S11, the robot 3 stops due to a specific cause, for example, the robot 3 interfering with a foreign object. As a result, for safety purposes, the built-in brake 50 is automatically activated to stop the motor shaft 13. Furthermore, the controller 9 stops energizing the motor 10, the primary encoder 15, and the secondary encoder 25. As a result, the joints of the robot 3 become immobile.

Next, in step S12, the operator releases the built-in brake 50 to allow the motor shaft 13 to rotate. The operator then manually starts to operate the robot 3 (step S13). At the same time, an encoder power source, for example, the controller 9, starts to supply power to at least one of the primary encoder 15 and the secondary encoder 25 (step S14).

In other words, in the first embodiment, in a predetermined situation, and specifically, when the robot 3 stops and the brake mechanism 50 is released, an encoder power source, for example, the controller 9, starts supplying power to at least one of the primary encoder 15 and the secondary encoder 25. As a result, the energized encoders 15, 25 continue to detect the absolute positions PA1, PA2 and the total rotation numbers PB1, PB2 (step S15).

Next, in step S16, when, for example, the robot 3 is sufficiently separated from the foreign object and the specific cause described above is eliminated, the operator manually stops the robot 3. When the robot 3 is stopped, the absolute positions PA1, PA2 and the total rotation numbers PB1, PB2 are stored in the memory 7, and the power supply from the encoder power source, for example, the controller 9, to at least one of the primary encoder 15 and the secondary encoder 25 is stopped (step S17). In step S18, the built-in brake 50 is activated again to prevent the motor shaft 13 from rotating. As a result, the robot 3 is in the same state as when the robot 3 was stopped in step S1.

Next, in step S19, it is determined whether or not there are operation commands for the robot 3. If there are no operation commands, the process waits until an operation command is received. If there is an operation command, the process proceeds to step S20, where the built-in brake 50 is again released. As a result, the motor shaft 13 becomes capable of rotation. In step S21, the controller 9 reads the absolute positions PA1, PA2 and the total rotation numbers PB1, PB2 stored in the memory 7. Thereafter, the controller 9 resumes the operation of the robot 3 in accordance with the operation commands received in step S19 (step S22).

As described above, in the first embodiment, after step S12, a situation occurs in which the robot 3 stops and the brake mechanism 50 is released. In this situation, the controller 9, which serves as an encoder power source, makes at least one of the primary encoder 15 and the secondary encoder 25 continue to detect positions, and stores the results in the memory 7 (steps S15 and S17). The contents of the memory 7 are then read, and the operation of the machine 3 is resumed (steps 21 and 22).

Thus, in the first embodiment, even when the shaft portion 23 performs a rotational operation of one to two rotations, the secondary encoder 25 can be used continuously throughout the entire movable range of the output shaft 23 without the need for an additional battery. Specifically, in the first embodiment of the present disclosure, it is possible to provide a position detection system 1 which can be used continuously throughout the entire movable range of the output shaft 23 without a battery. Note that the primary encoder 15 can also be used continuously throughout the entire movable range of the output shaft 23.

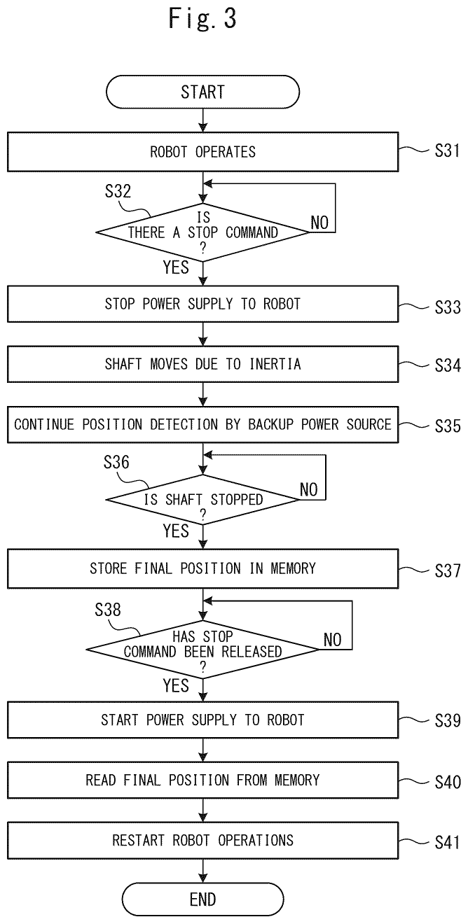

FIG. 3 is a flowchart showing the operations of the position detection system based on the second embodiment. The contents shown in FIG. 3 are implemented when the machine 3, for example, the robot 3, makes an emergency stop during operation. The program related to the operations shown in FIG. 3 is stored in a storage unit (not illustrated) connected to the controller 9. Below, the case in which the machine 3 is a robot 3 will be described, but the same can be applied when the machine 3 is a machine tool or the like.

First, in step S31, the robot 3 operates in accordance with the operation program thereof. In step S32, it is determined whether or not an emergency stop command for the robot 3 has been issued, and the operations of the robot 3 continue unless a stop command is issued. When a stop signal has been issued, the process proceeds to step S33.

When the stop signal is issued, the power supply from the controller 9 to the robot 3 is stopped (step S33). Specifically, the controller 9 stops energizing the motor 10, the primary encoder 15, and the secondary encoder 25. As a result, the joints of the robot 3 stop moving. At this time, though the motor 10 is stopped, the output shaft 23 of the speed reducer 20 continues to move due to inertia (step S34).

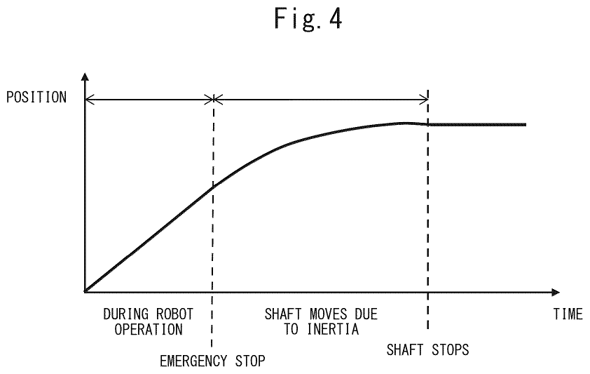

FIG. 4 is a view showing the relationship between time and the position of the output shaft of the speed reducer. In FIG. 4, the horizontal axis represents time, and the vertical axis represents the position of the output shaft 23 of the speed reducer 20. As shown in FIG. 4, even if the robot 3 is stopped by a stop signal, since the output shaft 23 moves due to inertia, the position of the output shaft 23 continues to change.

Thus, in step S35, the battery 8 (backup power source) serving as an encoder power source not only supplies power to the memory 7 but also to at least one of the primary encoder 15 and the secondary encoder 25.

In other words, in the second embodiment, in a predetermined situation, and specifically, in a situation in which the output shaft is moving due to inertia as a result of the power supply to the motor 10 being stopped, an encoder power source, for example, the battery 8, starts supplying power to at least one of the primary encoder 15 and the secondary encoder 25. As a result, the energized encoders 15, 25 continue to detect the absolute positions PA1, PA2 and the total rotation numbers PB1, PB2 (step S35).

As can be understood referring again to FIG. 4, the output shaft 23, which moves due to inertia, stops after moving for a certain period of time. When it is confirmed in step S36 that the output shaft 23 has stopped, the process proceeds to step S37, in which the absolute positions PA1, PA2 and the total rotation numbers PB1, PB2 are stored in the memory 7 (step S37).

In step S38, it is determined whether the stop command for the robot 3 has been released, and when it has been released, the process proceeds to step S39. In step S39, power supply from the controller 9 to the robot 3 is started. Specifically, in step S40, the controller 9 reads the absolute positions PA1, PA2 and the total rotation numbers PB1, PB2 stored in the memory 7. In accordance with the operation commands of the operation program for the robot 3, the operations of the robot 3 are resumed (step S41).

In this manner, in the second embodiment, after step S33, a situation occurs in which the output shaft moves due to inertia as a result of the power supply to the motor 10 being stopped. The position detection of at least one of the primary encoder 15 and the secondary encoder 25 is continued by the battery 8 as an encoder power source, and the results are stored in the memory 7 (steps S35, S37). The contents of the memory 7 are then read, and the operations of the machine 3 are resumed (steps 40, 41).

Thus, in the second embodiment, even when the shaft portion 23 performs a rotational operation of one to two rotations, the secondary encoder 25 can be used continuously throughout the entire movable range of the output shaft 23 without the need for an additional battery. Specifically, in the second embodiment of the present disclosure, it is possible to provide a position detection system 1 which can be used continuously throughout the entire movable range of the output shaft 23 without a battery. Note that the primary encoder 15 can also be used continuously throughout the entire movable range of the output shaft 23.

In the first and second embodiments, since the encoder power source is the controller 9 or the battery 8 of the position detection system 1, an additional power source or the like is not needed. The encoder power source (controller 9, battery 8) supplies power to at least one of the primary encoder 15 and the secondary encoder 25 in the predetermined situation described above. However, the encoder power source (controller 9, battery 8) may supply power to only the secondary encoder 25 in the predetermined situation described above. In such a case, the total number of rotations PB1 of the primary encoder 15 can be obtained based on the absolute position PA2 and the total number of rotations PB2 of the secondary encoder 25, and the absolute position PA1 can be calculated. Thus, it can be seen that less power is required for the encoder power source. Even such a case is included in the scope of the present disclosure.

### Aspects of the Present Disclosure

According to a first aspect, there is provided a position detection system comprising a primary encoder for detecting a position of a motor shaft of a motor, and a secondary encoder for detecting a position of an output shaft of a speed reducer coupled to the motor, and further comprising an encoder power source for energizing and operating at least one of the primary encoder and the secondary encoder in a predetermined situation.

According to a second aspect, in the first aspect, the predetermined situation is a situation in which the machine is stopped and a brake mechanism for stopping at least one of the motor shaft of the motor and the output shaft of the speed reducer is released.

According to a third aspect, in the second aspect, the encoder power source is a controller for controlling the machine.

According to a fourth aspect, in the first aspect, the predetermined situation is a situation in which the output shaft is moving due to inertia after power supply to the motor is stopped.

According to a fifth aspect, in the fourth aspect, the encoder power source is a capacitor or a backup battery.

According to a sixth aspect, in the first aspect, the encoder power source is configured to energize only the secondary encoder.

According to a seventh aspect, there is provided an actuator, comprising a motor, a speed reducer coupled to the motor, a primary encoder for detecting a position of a motor shaft of the motor, and a secondary encoder for detecting a position of an output shaft of the speed reducer, and further comprising an encoder power source for energizing and operating at least one of the primary encoder and the secondary encoder in a predetermined situation.

According to an eighth aspect, in the seventh aspect, the predetermined situation is a situation in which the machine is stopped and a brake mechanism for stopping at least one of the motor shaft of the motor and the output shaft of the speed reducer is released.

According to a ninth aspect, in the eighth aspect, the encoder power source is a controller for controlling the machine.

According to a tenth aspect, in the seventh aspect, the predetermined situation is a situation in which the output shaft is moving due to inertia after power supply to the motor is stopped.

According to an eleventh aspect, in the tenth aspect, the encoder power source is a capacitor or a backup battery.

According to a twelfth aspect, in the seventh aspect, the encoder power source is configured to energize only the secondary encoder.

According to a thirteenth aspect, there is provided a position detection method for a position detection system comprising a primary encoder for detecting a position of a motor shaft of a motor and a secondary encoder for detecting a position of an output shaft of a speed reducer coupled to the motor, the method comprising the steps of in response to a stop command for the machine, stopping power supply to the motor, whereby the rotor of the motor moves by inertia, by means of an encoder power source, energizing and operating at least one of the primary encoder and the secondary encoder, and storing the position of at least one of the primary encoder and the secondary encoder when the output shaft stops.

According to a fourteenth aspect, in the thirteenth aspect, the encoder power source is a capacitor or a backup battery.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

Though the embodiments of the present disclosure are described above, it should be understood by a person skilled in the art that various modifications and changes can be made without departing from the scope of the claims, which are described below.

### REFERENCE SIGNS LIST

1 position detection system
3 machine (robot)
5 position detection system
6 actuator
7 memory
8 battery (encoder power source)
9 controller (encoder power source)
10 motor
11 stator
12 rotor
13 motor shaft
15 primary encoder
16 detection unit
20 speed reducer
23 output shaft
25 secondary encoder
26 detection unit
50 built-in brake

1. A position detection system comprising:
a primary encoder for detecting a position of a motor shaft of a motor, and
a secondary encoder for detecting a position of an output shaft of a speed reducer coupled to the motor, and further comprising:
an encoder power source for energizing and operating at least one of the primary encoder and the secondary encoder in a predetermined situation.

2. The position detection system according to claim 1, wherein the predetermined situation is a situation in which the machine is stopped and a brake mechanism for stopping at least one of the motor shaft of the motor and the output shaft of the speed reducer is released.

3. The position detection system according to claim 2, wherein the encoder power source is a controller for controlling the machine.

4. The position detection system according to claim 1, wherein the predetermined situation is a situation in which the output shaft is moving due to inertia after power supply to the motor is stopped.

5. The position detection system according to claim 4, wherein the encoder power source is a capacitor or a backup battery.

6. The position detection system according to claim 1, wherein the encoder power source is configured to energize only the secondary encoder.

7. An actuator, comprising:
a motor,
a speed reducer coupled to the motor,
a primary encoder for detecting a position of a motor shaft of the motor, and
a secondary encoder for detecting a position of an output shaft of the speed reducer, and further comprising:
an encoder power source for energizing and operating at least one of the primary encoder and the secondary encoder in a predetermined situation.

8. The actuator according to claim 7, wherein the predetermined situation is a situation in which the machine is stopped and a brake mechanism for stopping at least one of the motor shaft of the motor and the output shaft of the speed reducer is released.

9. The actuator according to claim 8, wherein the encoder power source is a controller for controlling the machine.

10. The actuator according to claim 7, wherein the predetermined situation is a situation in which the output shaft is moving due to inertia after power supply to the motor is stopped.

11. The actuator according to claim 10, wherein the encoder power source is a capacitor or a backup battery.

12. The actuator according to claim 7, wherein the encoder power source is configured to energize only the secondary encoder.

13. A position detection method for a position detection system comprising a primary encoder for detecting a position of a motor shaft of a motor and a secondary encoder for detecting a position of an output shaft of a speed reducer coupled to the motor, the method comprising the steps of:
in response to a stop command for the machine, stopping power supply to the motor, whereby the rotor of the motor moves by inertia,
by means of an encoder power source, energizing and operating at least one of the primary encoder and the secondary encoder, and
storing the position of at least one of the primary encoder and the secondary encoder when the output shaft stops.

14. The position detection method according to claim 13, wherein the encoder power source is a capacitor or a backup battery.
